(19) United States
(12) Patent Application Publication
(10) Pub. No.: US 2006/0123358 A1
(43) Pub. Date: Jun. 8, 2006

(54) Method and system for generating input grammars for multi-modal dialog systems

(76) Inventors: Hang Shun Lee, Palatine, IL (US); Anurag K. Gupta, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/004,339

(22) Filed: Dec. 3, 2004

(51) Int. Cl. G06F 17/00; G06F 3/00; G06F 17/27

(52) U.S. Cl. 715/809; 715/700; 704/9

(57) ABSTRACT

A method for operating a multi-modal dialog system (104) is provided. The multi-modal dialog system (104) comprises a plurality of modality recognizers (202), a dialog manager (206), and a grammar generator (208). The method interprets a current context of a dialog. A template (216) is generated, based on the current context of the dialog and a task model (218). Further, a current modality capability information (214) is obtained. Finally, a multi-modal grammar (220) is generated based on the template (216) and the current modality capability information (214).

### RELATED APPLICATIONS

This application is related to U.S. application, Ser. No. 10/853,540 having a filing date of May 25, 2004, which is assigned to the assignee hereof.

### FIELD OF THE INVENTION

This invention is in the field of software and more specifically is in the field of software that generates input grammar for multi-modal dialog systems.

### BACKGROUND

Dialog systems are systems that allow a user to interact with a computer system to perform tasks such as retrieving information, conducting transactions, and other such problem solving tasks. A dialog system can use several modalities for interaction. Examples of modalities include speech, gesture, touch, handwriting, etc. User-computer interactions in dialog systems are enhanced by employing multiple modalities. The dialog systems using multiple modalities for human-computer interaction are referred to as multi-modal dialog systems. The user interacts with a multi-modal dialog system using a dialog based user interface. A set of interactions of the user and the dialog system is referred to as a dialog. Each interaction is referred to as a turn of the dialog. The information provided by either the user or the dialog system is referred to as a context of the dialog.

A conventional multi-modal dialog system comprises a plurality of modality recognizers, a multi-modal input fusion component, and a dialog manager. The dialog based user interface is coupled with the plurality of modality recognizers. Examples of the modality recognizers include speech recognizers, gesture recognizers, handwriting recognizers, etc. These modality recognizers accept and interpret user input. Each modality recognizer uses a modality specific grammar for interpreting the input. A modality specific grammar is a set of rules for interpreting user input. The modality recognizers produce multi-modal interpretations of the user input. The multimodal interpretations are then analyzed by the multi-modal input fusion component. The multi-modal input fusion component determines probable meanings of the multi-modal interpretations. The dialog manager uses a combined interpretation of the user input, generated by the multi-modal input fusion component, to update the dialog context. The dialog manager then selects a modality specific grammar from a pre-compiled list of modality specific grammars for the next input.

The modality specific grammars used by the dialog system are manually created at the time of development of the dialog system. This generation is a labor intensive and time-consuming process. Further, multi-modal dialog systems do not incorporate current dialog context information into the modality specific grammar generation. This results in a large number of recognition and interpretation errors.

A dialog based system is described in a publication titled “Correction Grammars for Error Handling in a Speech Dialog System”, by Hirohiko Sagawa, Teruko Mitamura, and Eric Nyburg, and published in the Human Language Technology Conference of the North American Chapter of the Association of Computational Linguistics, 2004, short paper, pp 61-64. In this system, grammar rules are dynamically generated using dialog contexts. The dialog contexts are used for error corrections.

The existing dialog based systems do not consider use of different modalities in a coordinated manner, i.e. the dialog systems do not use a combined interpretation of user input. Further, the dialog systems generate only modality specific or uni-modal grammars.

### BRIEF DESCRIPTION OF THE DRAWINGS

The present invention is illustrated by way of example, and not limitation, by the accompanying figures, in which like references indicate similar elements, and in which:

FIG. 1 is a block diagram of a multi-modal dialog system, in accordance with some embodiments of the present invention;

FIG. 2 is a block diagram of an input processor in the multi-modal dialog system, in accordance with some embodiments of the present invention;

FIG. 3 shows a flow chart that illustrates the different steps of the method for processing the input in the multi-modal dialog system, in accordance with some embodiments of the present invention;

FIG. 4 shows a flow chart that illustrates the different steps of grammar generation, in accordance with some embodiments of the present invention;

FIG. 5 is a block diagram of a non-terminal grammar rule, in accordance with one embodiment of the present invention;

FIG. 6 is a block diagram of a multi-modal grammar rule, in accordance with one embodiment of the present invention; and

FIG. 7 is a block diagram of an input processor in the multi-modal dialog system in accordance with another embodiment of the present invention.

Those skilled in the art will appreciate that the elements in the figures are illustrated for simplicity and clarity, and have not been necessarily drawn to scale. For example, the dimensions of some of the elements in the figures may be exaggerated, relative to other elements, for improved perception of the embodiments of the present invention.

### DETAILED DESCRIPTION OF THE DRAWINGS

Before describing in detail a method and system for generating input grammar in a multi-modal dialog system, in accordance with the present invention, it should be observed that the present invention resides primarily in combinations of method steps and apparatus components related to multimodal dialog-based user interfaces. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art and the benefit of the description herein.

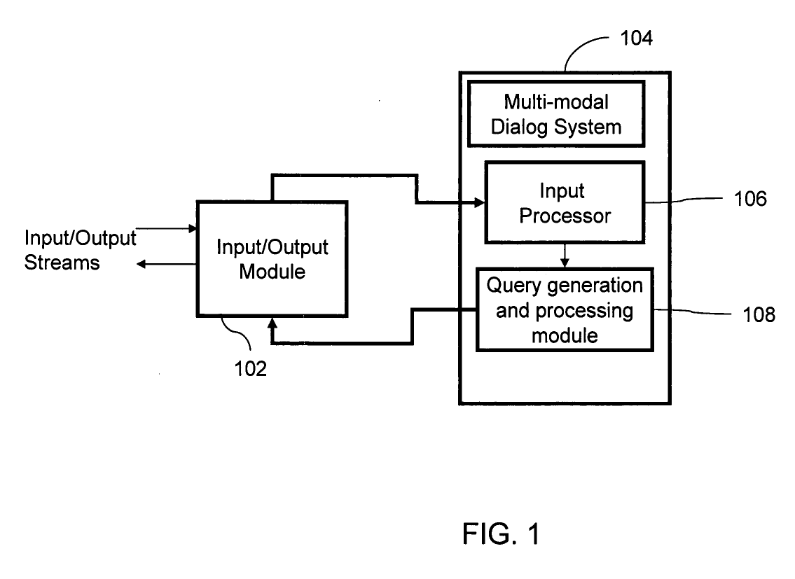

Referring to FIG. 1, a block diagram shows a representative environment in which the present invention may be practiced, in accordance with some embodiments of the present invention. The representative environment consists of an input-output module 102 and a multi-modal dialog system 104. The input-output module 102 is responsible for receiving user inputs and displaying system outputs. The input-output module 102 can be a user interface, such as a computer monitor, a touch screen, and a keyboard. A user interacts with the multi-modal dialog system 104 via the input-output module 102. This interaction of the user with the multi-modal dialog system 104 is referred to as a dialog. Each dialog may comprise a number of interactions between the user and the multi-modal dialog system 104. Each interaction is referred to as a turn of the dialog. The information provided by the user at each turn of the dialog is referred to as a context of the dialog. The multi-modal dialog system 104 comprises an input processor 106 and a query generation and processing module 108. The input processor 106 interprets and processes the input from the user and provides the interpretation to the query generation and processing module 108. The query generation and processing module 108 further processes the interpretation and performs tasks such as retrieving information, conducting transactions, and other such problem solving tasks. The results of the tasks are returned to the input-output module 102, which displays the results to the user.

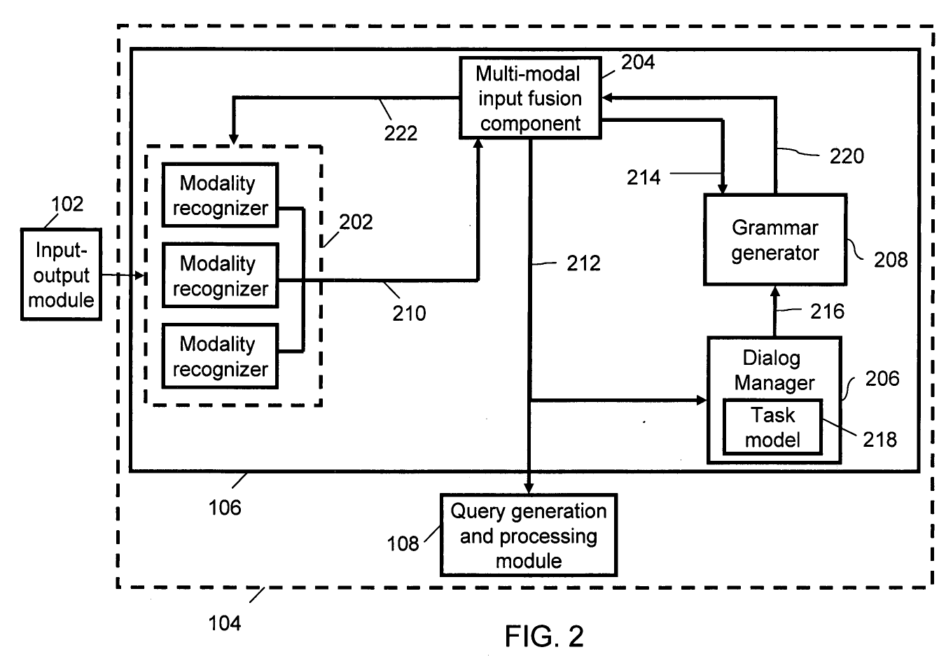

Referring to FIG. 2, a block diagram shows the input processor 106 in the multi-modal dialog system 104, in accordance with some embodiments of the present invention. The input processor 106 comprises a plurality of modality recognizers 202, a multi-modal input fusion (MMIF) component 204, a dialog manager 206, and a grammar generator 208. The plurality of modality recognizers 202 accept and interpret user input. The user can provide the input, using various modalities through one or more input-output modules, of which one input-output module 102 is shown. The various modalities that can be used include, but are not limited to, voice, gesturing, and handwriting. The working of the various modality recognizers is well understood by those with ordinary skill in the art. Examples of modality recognizers 202 include a speech recognizer, a handwriting recognizer, a gesture recognizer, and a command recognizer. Each modality recognizer generates one or more multi-modal interpretations (MMIs) 210 at each turn of the dialog. The MMIF component 204 integrates one or more multi-modal interpretations 210 into one or more combined semantic meaning representations 212. The MMIF component 204 maintains a record of modality capability information 214, i.e., the capabilities of the modalities that were used at each previous turn of the dialog. Further, the MMIF 204 updates this record of modality capability information 214 at the turn of the dialog. The dialog manager 206 generates a template 216 that is used for grammar generation. The template 216 is based on the one or more combined semantic meaning representations 212 and a task model 218. The task model 218 is a data structure used to model a task. Further, the dialog manager 206 maintains and updates the contexts of the dialog. The grammar generator 208 generates a multi-modal grammar 220, which is used to interpret the next user input. The multi-modal grammar 220 is generated based on the template 216 and the modality capability information 214. The multi-modal grammar 220 is combined into a network grammar (not shown in FIG. 2) which is a collection of all the multi-modal grammars generated until the present turn of the dialog. The multi-modal grammar is filtered into a plurality of modality specific grammars 222, which are provided to the plurality of modality recognizers 202.

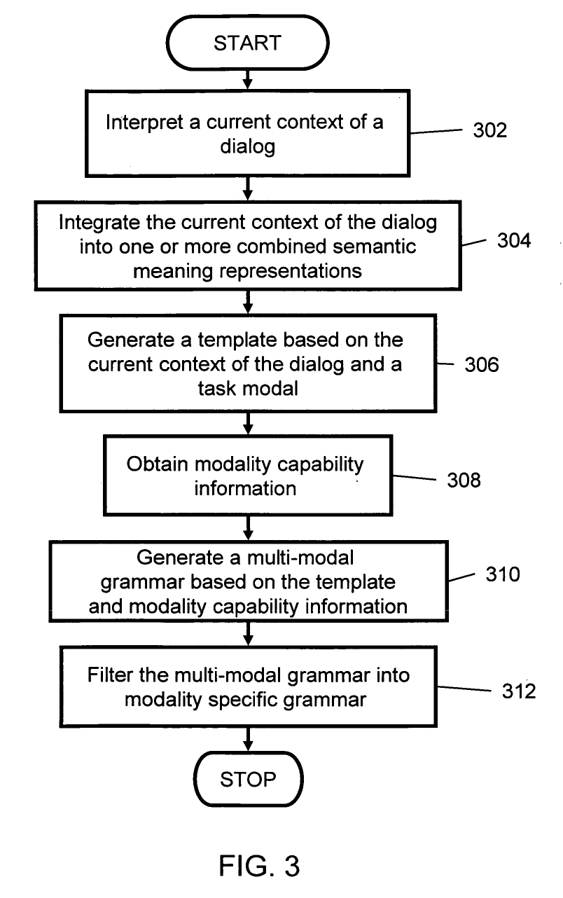

Referring to FIG. 3, a flow chart shows steps of the method for processing the input in the multi-modal dialog system 104, in accordance with some embodiments of the present invention. At step 302, the plurality of modality recognizers 202 accept and interpret the context of the dialog at each turn. Each modality recognizer contains a modality-specific set of rules, referred to as a modality specific grammar. The plurality of modality recognizers 202 interpret the user input with the help of the plurality of modality specific grammars 222 available and generate the one or more multi-modal interpretations 210. In accordance with various embodiments of the present invention, the plurality of modality specific grammars 222 are provided to the plurality of modality recognizers 202 at each turn of the dialog. These plurality of modality specific grammars 222 are provided by the MMIF component 204. Each multi-modal interpretation in the one or more multi-modal interpretations 210 is a uni-modal interpretation, i.e., each is an interpretation of the context of the dialog from one modality, but multi-modal interpretations are so called herein because they may be generated by any of a plurality of modalities. For example, when a user says, “Get information on this hotel” and touches a point on a map, using a touch screen, a speech and touch modality interpret the input. The touch modality produces three interpretations of the input, ‘region’, ‘hotel’ and ‘point’. The point on the map may be interpreted as a region on the map or a hotel that is on it. The interpretation of hotel provides information to access different attributes of the hotel, i.e., name, address, number of rooms, and/or other details. The interpretation of region provides information about the region on the map, i.e., the name of the region, its population, and/or other details. The interpretation of point provides information pertaining to the coordinates of the hotel or region on the map. Similarly, the speech modality produces two interpretations of the input ‘zoom to point’ and ‘information on hotel’. The interpretation of ‘zoom to point’ provides the attributes required to locate the hotel or region on the map. The interpretation of ‘information on hotel’ provides attributes required to obtain information about the hotel. The one or more MMIs 210, generated thus, are received by the multi-modal input fusion (MMIF) component 204. At step 304, the MMIF component 204 integrates the one or more MMIs 210 into the one or more combined semantic meaning representations 212 at the turn of the dialog. For the multi-modal interpretations in the example given above, the interpretations of the speech modality and touch modality are combined, to form a single representation. In this example, the values of the attributes, which are specified by the speech interpretations, are provided by the touch interpretations. The one or more combined semantic meaning representations 212 are generated by multi-modal fusion algorithms. Multi-modal fusion algorithms include those that are known to those of ordinary skill in the art, and may include new algorithms such as those elaborated on in detail in U.S. application Ser. No. 10/853,540 having a filing date of May 25, 2004,

The one or more combined semantic meaning representations 212 may provide information such as the start time and end time of each turn of the dialog, the type of task performed, the modalities used at the turn of the dialog, the context of the dialog, and identification of the turn at which the information was provided by the user. Further, the one or more combined semantic meaning representations 212 may also provide the start and end time of use of each modality. The information related to the starting and ending time of the use of each modality helps in coordinating the information from various modalities. The MMIF component 204 provides the modality capability information 214 to the grammar generator 208. The modality capability information 214 provides information about the type of modalities being used by the user at the turn of the dialog. Further, the MMIF component 204 provides the one or more combined semantic representations 212 to the dialog manager 206. At step 306, the dialog manager 206 generates the template 216, using the one or more combined semantic meaning representations 212 of the turn of the dialog, and the task model 218. The task model 218 elaborates on the knowledge necessary for completing the task. The knowledge required for the task includes the task parameters, their relationships, and the respective attributes required to complete the task. This knowledge of the task is organized in the task model 218.

The template 216 specifies the information expected to be received from the user, as well as the form in which the user may produce the input. The form refers to the type of information the user may provide. Examples of form include a request, a wh-question, etc. For example, if the form of the template 216 is a wh-question, it means that the user is expected to ask a ‘what’, ‘where’ or ‘when’ type of question at the next turn of the dialog. If the form of the template 216 is a request, it means that the user is expected to make a request for the performance of a task. The template 216 encapsulates this information and knowledge, which is available only at runtime. An exemplary template is illustrated below.

(template
(SOURCE obligation)
(FORM request)

(ACT

(TYPE GoToPlace)

(PARAM

(Place

NAME “”
SUBURB “”

)

)

)

)

The template, illustrated above, is generated by using one or more combined semantic meaning representations of the current dialog context and the task the user intends to perform. For example, the task specified in the above template is ‘GoToPlace’, i.e., the multi-modal dialog system 102 has determined that the user probably wants to plan a visit to a particular place. According to the task, the corresponding task model is chosen, and parameters for the task are selected. Further, the attribute values of the parameters are also selected. For example, the parameter ‘place’ is selected for the task, GoToPlace. Task parameter ‘place’, in turn, has two attribute values, ‘NAME’ and ‘SUBURB’. Further, the template provides the type of form, e.g., the form of the template shown is a ‘request’, implying that the user's intention is to request the performance of the task.

Moreover, the template is generated so that all the possible expected user inputs are included. For this, one or more of the following group of dialog concepts are used: discourse expectation, task elaboration, task repair, look-ahead and global dialog control.

In discourse expectation, the task model and the semantic meaning representation of the current context of the dialog helps in understanding and anticipating the next user input. In particular, they provide information on the discourse obligations imposed on the user at the turn of the dialog. For example, a system question, such as “Where do you want to go?”, will result in the user responding with the name of a location.

In some cases, the user may augment the input with further information not required by the dialog, but necessary for the progress of the task. For this, the concept of task elaboration is used to generate the template, to incorporate any additional information provided by the user. For example, for a system question, such as “Where do you want to go?”, the system expects the user to provide a location name, but the user may respond with “Chicago tomorrow”. The template that is generated for interpreting the expected user response is such that the additional information (which is ‘tomorrow’ in this example) can be handled. The template specifies that a user may provide additional information related to the expected input, based on the current context of the dialog and information from the previous turn of the dialog. In the above example, the template specified that the user may provide a time parameter along with the location name, and as in the previous dialog turn, the system knows that the user is planning a trip, as the template used is ‘GoToPlace’.

The concept of task repair offers an opportunity to correct an error in the dialog turn. For the dialog mentioned in the previous paragraph, the system may interpret the user's response of ‘Chicago’ wrongly as ‘Moscow’. The system, at the next turn of the dialog, asks the user for confirmation of the information provided as, “Do you want to go to Moscow?”. The user may respond with, “No, I said Chicago”. Hence, the information at the dialog turn is used for error correction.

The concept of the look-ahead strategy is used when the user performs a sequence of tasks without the intervention of the dialog manager 206 at every single turn. In this case, the current dialog information is not sufficient to generate the necessary template. To account for this, the dialog manager 206 uses the look-ahead strategy to generate the template.

To continue with the dialog mentioned in the previous paragraphs, in response to the system question “Where do you want to go?”, a user may reply with “Chicago tomorrow.”, and then “I want to book a rental car too” without waiting for any system output for the first response. In this case, the user performs two tasks, specifying a place to go to and requesting a rental car, in a single dialog turn. Only the first task is expected from the user given the current dialog information. Templates are generated based on this expectation and the task model, which specifies additional tasks that are likely to follow the first task. That is, the system “looks ahead” to anticipate what a user would do next after the expected task.

The user may produce an input to the system that is not directly related to the task, but is required to maintain or repair the consistency or logic of the interaction. Example inputs include a request for help, confirmation, time, contact management, etc. This concept is called global dialog control. For example, at any point in the dialog, the user may ask for help with “Help me out“. In response, the system obtains context-dependent instructions. Another example can be a user requesting the cancellation of the previous dialog with “Cancel”. In response, the system undoes the previous request.

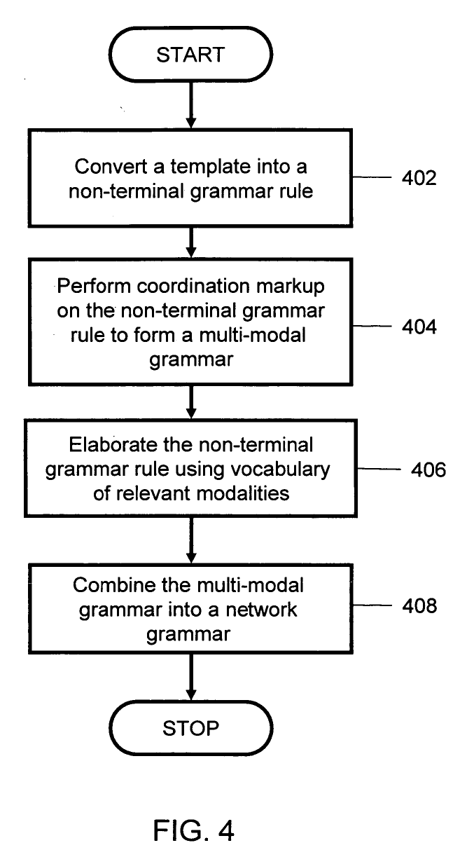

At step 308, the grammar generator 208 obtains the modality capability information 214 from the MMIF component 204. At step 310, the grammar generator 208 generates the multi-modal grammar 220, using the template 216 and the modality capability information 214 from the MMIF component 204. The process of multi-modal grammar 220 generation is explained later in conjunction with FIG. 4. At step 312, the multi-modal grammar 220 is given to the MMIF component 204, which filters the multi-modal grammar 220 into the plurality of modality specific grammars 222. The plurality of modality recognizers 202 use the one or more of the plurality of modality specific grammars 222 to interpret the user input and provide the one or more MMIs 210 to the MMIF component 204 at the next turn of the dialog. This process continues until the dialog is completed.

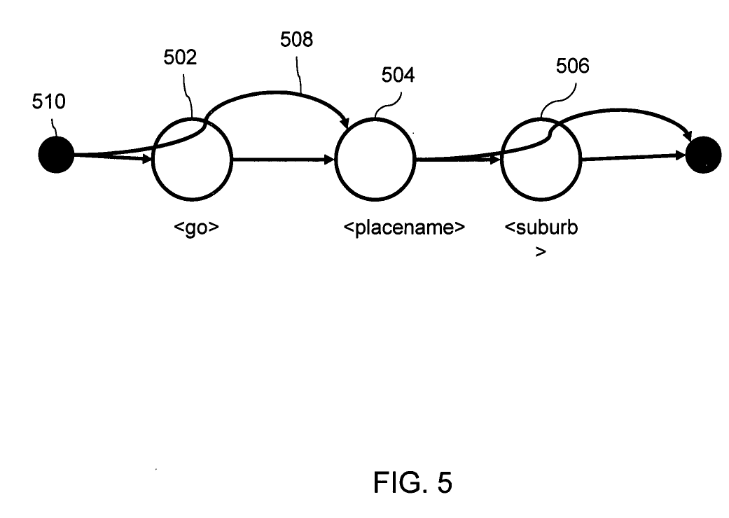

Referring to FIG. 4, a flow chart shows the steps of multi-modal grammar generation, which are carried out by the grammar generator 208. At step 402, the template 216, generated by the dialog manager 206, is converted into a non-terminal grammar rule. Referring to FIG. 5, a block diagram illustrates the non-terminal grammar rule, which consists of a network of non-terminals 502, 504 and 506. Each non-terminal corresponds to a piece of semantic information relevant to a turn of the dialog. The piece of semantic information represents a part of the combined semantic meaning representation according to the structure of the task model 218. For example, for the ‘GoToPlace’ template explained earlier, the semantic information is represented by non-terminals 502, 504 and 506. The non-terminal 502 represents ‘go’, the non-terminal 504 ‘placename’, and the non-terminal 508 ‘suburb’. Connections or lines connecting the non-terminals represent the modalities that are used to obtain pieces of semantic information for the next turn of the dialog. In case two pieces of semantic information are obtained together, a connection spans across two non-terminals. For example, a user can say, “I want to go to Chicago”. For this example, a connection 508 is shown that connects a terminal 510 to the non-terminal 504. Further, in case a piece of semantic information can be obtained by two different modalities, then two connections are shown between the non-terminals. At step 404, the grammar generator 208 performs a coordination markup on the non-terminal grammar rule, to generate the corresponding multi-modal grammar 220. The coordination markup converts the piece of semantic information into a system-readable format. Further, the coordination markup takes into account the timings of the use of various modalities. Different markup languages such as XML, multi-modal markup language (M3L), and extended XML, can be used to perform the markup.

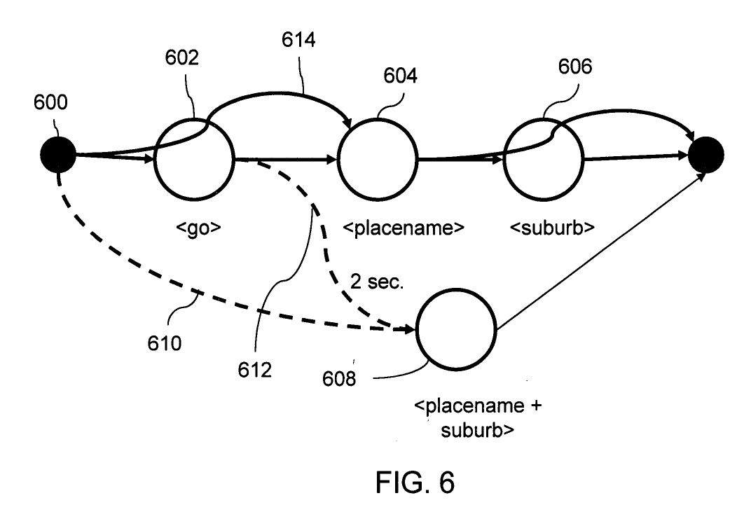

Referring to FIG. 6, a block diagram represents the multi-modal grammar 220, generated after performing the coordination markup on the non-terminal grammar rule illustrated in FIG. 5. 602, 604, 606, and 608 represent the network of non-terminals. Each non-terminal represents a piece of semantic information relevant to the dialog. The modality capability information 214 from the MMIF component 204 is also attached to the non-terminal grammar rule. A connection 610 represents that the modality used is touch, and a connection 614 represents that the modality used is speech. The information is represented according to defined rules attached to the non-terminals 602, 604, 606 and 608 and the connections 610, 612 and 614. An example of a rule is modality capability. An example of the rule can be a sequence of non-terminals to be supplied with the same modality. For example, speech may be used for the sequence of non-terminals 602, 604 and 606. In another example, as shown in FIG. 6, touch may generate the semantic information for both placename and suburb 608. Another rule, which can be used, is the temporal order between modalities. For example, as shown in FIG. 6 by link 612 the touch for placename has to occur less than two seconds after ‘go’ with speech. Moreover, a combination of one or more rules can also be used.

At step 406, the non-terminal grammar rule is elaborated, using a vocabulary of relevant modalities. Symbols and rules specific to each modality are used, to elaborate a part of the multi-modal grammar 220 corresponding to a modality. For example, in handwriting recognition, various symbols are replaced by their unabbreviated forms. Symbols like ‘&’ are replaced by ‘ampersand’, or ‘and’, ‘<’ is replaced by ‘less than’. At step 408, the generated multi-modal grammar 220 is combined into a network grammar. The network grammar is a combination of all the multi-modal grammars generated until the turn of the dialog. The network grammar represents a collection of meaningful sentences, all possible words, and meanings. This is done to represent all the possible user inputs for the next turn of the dialog. The network grammar helps the plurality of modality recognizers 202 to interpret the user input correctly.

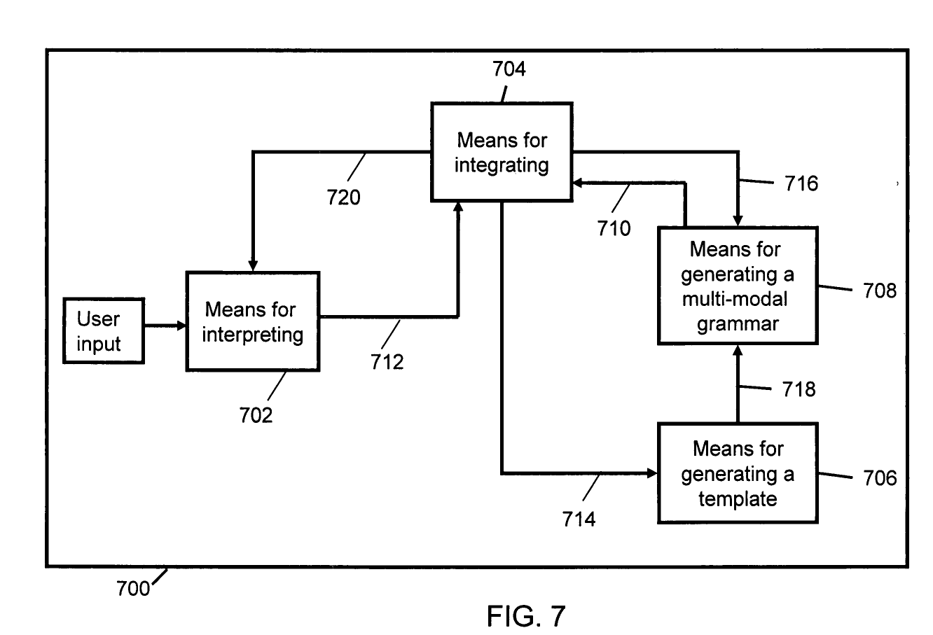

Referring to FIG. 7, a block diagram shows an electronic equipment 700, in accordance with another embodiment of the present invention. The electronic equipment 700 comprises a means for interpreting 702, a means for integrating 704, a means for generating a template 706, and a means for generating multi-modal grammar 708. The means for interpreting 702 accepts and interprets the user input. The information provided by the user is referred to as a current context of the dialog. The means for interpreting 702 interprets the user input using a multi-modal grammar 710 generated by the means for generating multi-modal grammar 708. Further, the means for interpreting 702 generates multi-modal interpretations 712 of the current context of the dialog. The means for integrating 704 obtains the multi-modal interpretations 712 of the current context of the dialog from the means for interpreting 702. The means for integrating 704 generates one or more combined semantic meaning representations 714 of the current context of the dialog using the multi-modal interpretations 712. Further, the means for integrating 704 obtains modality capability information 716, i.e. the type of modality through which the user provides the input to the means for interpreting 702. The means for generating a template 706 generates a template 718 of expected user input from the one or more combined semantic meaning representations. The means for generating a multi-modal grammar 708 generates the multi-modal grammar 710 based on the modality capability information and the template. The multi-modal grammar 710 is obtained by the means for integrating 704. The means for integrating 704 filters the multi-modal grammar 710 into a plurality of modality specific grammars 720. This plurality of modality specific grammars 720 is provided to the means for interpreting 702. The means for interpreting 702 utilizes the plurality of modality specific grammars 720 for interpreting the next user input.

It will be appreciated that the method for generating a multi-modal grammar in a multi-modal dialog system described herein, may comprise one or more conventional processors and unique stored program instructions that control the one or more processors to implement some, most, or all of the functions described herein; as such, the functions of generating multi-modal interpretations and generating combined semantic meaning representations may be interpreted as being steps of the method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

The method to generate multi-modal grammar as described herein can be used in multi-modal devices. For example, a handset where a user can input with speech, keypad, or a combination of both. The method can also be used in multi-modal applications for personal communication systems (PCS). The method can be used in commercial equipments ranging from extremely complicated computers to robots to simple pieces of test equipment, just to name some types and classes of electronic equipment. Further, the range of applications extends to all areas where access to information and browsing takes place with a multi-modal interface.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises”, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a non-empty set (i.e., for the sets defined herein, comprising at least one member). The term “another”, as used herein, is defined as at least a second or more. The term “having”, as used herein, is defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for operating a multi-modal dialog system, the method comprising:
interpreting a current context of a dialog in the multi-modal dialog system;
generating a template based on the current context of the dialog and a task model;
obtaining a current modality capability information; and
generating a multi-modal grammar based on the template and the current modality capability information.

2. The method according to claim 1 further comprising:
filtering the multi-modal input grammar into one or more modality specific grammars; and
generating interpretations of the dialog during a turn using the one or more modality specific grammars.

3. The method according to claim 2 further comprising:
integrating the interpretations of the dialog into one or more combined semantic meaning representations.

4. The method according to claim 1, wherein generating the template comprises one or more of a group of techniques consisting of using discourse expectation, task elaboration, task elaboration, task repair, look ahead strategy and global dialog control.

5. The method according to claim 1, wherein generating the multi-modal grammar comprises:
converting the template into a non-terminal grammar rule;
performing coordination markup on the non-terminal grammar rule; and
elaborating the non-terminal grammar rule using a vocabulary of relevant modalities.

6. The method according to claim 1 further comprising combining the multi-modal grammar into a network grammar.

7. A multi-modal dialog system comprising:
a plurality of modality recognizers, the plurality of modality recognizers generating interpretations of user input obtained during a turn of dialog through various modalities;
a dialog manager, the dialog manager generating a template based on a current context of the dialog; and
a grammar generator, the grammar generator generating multi-modal input grammar based on the template and a current modality capability information.

8. The multi-modal dialog system according to claim 7 wherein the dialog manager maintains and updates the current context of the dialog.

9. The multi-modal dialog system according to claim 7 further comprising a multi-modal input fusion component, the multi-modal input fusion component integrating the interpretations of the dialog into one or more combined semantic meaning representation.

10. The multi-modal dialog system according to claim 7 further comprising a multi-modal input fusion component, the multi-modal input fusion component filtering the multi-modal input grammar into one or more modality specific grammars that are used by the plurality of modality recognizers to interpret the user input.

11. A computer program product for use with a computer, the computer program product comprising a computer usable medium having a computer readable program code embodied therein for operating a multi-modal dialog system, the computer readable program code performing:
interpreting a current context of a dialog in the multi-modal dialog system;
generating a template based on the current context of the dialog and a task model;
obtaining a current modality capability information; and
generating a multi-modal grammar based on the template and the current modality capability information.

12. The computer program product in accordance with claim 11, wherein the computer readable program code further performing:
filtering the multi-modal input grammar into one or more modality specific grammars; and
generating interpretations of the dialog during a turn using the one or more modality specific grammar.

13. The computer program product in accordance with claim 12, wherein the computer readable program code further integrates the interpretations of the dialog into one or more combined semantic meaning representations.

14. The computer program product in accordance with claim 11, wherein the computer readable program code generates the template using one or more group of techniques consisting of discourse expectation, task elaboration, task repair, look ahead strategy and global dialog control.

15. The computer program product in accordance with claim 11, wherein the computer readable program code performing the step of generating the multi-modal grammar, the computer readable program code further performs:
converting the template into a non-terminal grammar rule;
performing coordination markup on the non-terminal grammar rule; and
elaborating the non-terminal grammar rule using a vocabulary of relevant modalities.

16. The computer program product in accordance with claim 11, wherein the computer readable program code further filters the multi-modality grammar into one or more modality specific grammars.

17. An electronic equipment for operating a multi-modal dialog system, comprising:
means for interpreting a current context of a dialog in the multi-modal dialog;
means for generating a template based on the current context of the dialog and a task model;
means for obtaining a current modality capability information; and
means for generating a multi-modal grammar based on the template and the current modality capability information.
